(19) United States
(12) Patent Application Publication
(10) Pub. No.: US 2016/0234487 A1
(43) Pub. Date: Aug. 11, 2016

(54) AUTOSTEREOSCOPIC DISPLAY DEVICE

(71) Applicant: KONINKLIJKE PHILIPS N.V., Eindhoven (NL)

(72) Inventors: BART KROON, EINDHOVEN (NL); MARK THOMAS JOHNSON, EINDHOVEN (NL); OLEXANDR VALENTYNOVYCH VDOVIN, EINDHOVEN (NL); EIBERT GERJAN VAN PUTTEN, EINDHOVEN (NL)

(21) Appl. No.: 15/022,578

(22) PCT Filed: Sep. 23, 2014
(86) PCT No.: PCT/EP2014/070244

§ 371 Date: Mar. 17, 2016

(30) Foreign Application Priority Data
Sep. 30, 2013 (EP) 13186635.2

(51) Int. Cl. H04N 13/04; G02B 27/26; G02B 27/22

(52) U.S. Cl. CPC H04N 13/0452; H04N 13/0404; G02B 27/2214; G02B 27/26; H04N 13/0409

(57) ABSTRACT

An autostereoscopic display device uses a view forming arrangement which comprises a first array of first optical elements associated with 3D pixels for generating 3D images, and a second array of second optical elements associated with other display pixels for generating 2D viewing images. In this way, an improved 2D resolution function is enabled without the need to make the display switchable between viewing modes.

### FIELD OF THE INVENTION

This invention relates to an autostereoscopic display device which comprises a display panel having an array of display pixels, and an arrangement for directing different views to different physical locations.

### BACKGROUND OF THE INVENTION

A known autostereoscopic display device comprises a two-dimensional liquid crystal display panel having a row and column array of display pixels acting as an image forming means to produce a display. An array of elongated lenses extending parallel to one another overlies the display pixel array and acts as a view forming means. These are known as “lenticular lenses”. As an alternative to these lenticular lenses, the lenses may be circular in a cross section parallel to the array or have another form e.g. an “elongated circle”. In the field of 3D displays such lenses are generally denoted “microlenses”. Outputs from the display pixels are projected through these microlenses or lenticular lenses, which function is to modify the directions of the outputs.

The lenticular lenses are provided as a sheet of lens elements, each of which comprises an elongate partial-cylindrical (e.g. semi-cylindrical) lens element. The lenticular lenses extend in the column direction of the display panel, with each lenticular lens overlying a respective group of two or more adjacent columns of display sub-pixels.

Each lenticular lens can be associated with two columns of display sub-pixels to enable a user to observe a single stereoscopic image. Instead, each lenticular lens can be associated with a group of three or more adjacent display sub-pixels in the row direction. Corresponding columns of display sub-pixels in each group are arranged appropriately to provide a vertical slice from a respective two dimensional sub-image. As a user's head is moved from left to right a series of successive, different, stereoscopic views are observed creating, for example, a look-around impression.

The above described autostereoscopic display device produces a display having good levels of brightness. However, one problem associated with the device is that the views projected by the lenticular sheet are separated by dark zones caused by “imaging” of the non-emitting black matrix which typically defines the display sub-pixel array. These dark zones are readily observed by a user as brightness non-uniformities in the form of dark vertical bands spaced across the display. The bands move across the display as the user moves from left to right and the visual pitch of the bands changes as the user moves towards or away from the display. Another problem is that the vertically aligned lens results in a reduction in resolution in the horizontal direction only, while the resolution in the vertical direction is not altered.

Both of these issues can be at least partly addressed by the well-known technique of slanting the lenticular lenses at an acute angle relative to the column direction of the display pixel array. The use of slanted lenses is thus recognised as an essential feature to produce different views with near constant brightness, and a good RGB distribution behind the lenses.

Whilst autostereoscopic 3D displays provide excellent viewing experience for 3D video and pictures, a good 2D performance—as is required especially for viewing text—is obtainable only in known displays where the autostereoscopic viewing arrangement is made switchable from the 2D to 3D mode. The same holds for full parallax autostereoscopic 3D displays based on microlenses.

There are many approaches to realise switchable 2D/3D displays. However, these are generally expensive solutions which may also compromise on the 3D or 2D performance, for instance due to a non-uniform lens shape in 3D mode or a residual lens effect in 2D mode, respectively. There remains a problem in enabling good 2D performance to be obtained on a non-switchable display which can also be viewed in a 3D mode. Without such solution the only way to improve 2D performance is by increasing the resolution of the display panel to a multiple of the desired 2D resolution.

### SUMMARY OF THE INVENTION

The invention is defined by the claims.

According to the invention, there is provided an autostereoscopic display device comprising: a display having an array of display pixels for producing a display output, a non-switchable view forming arrangement arranged in registration with the display for projecting a plurality of views towards a user in different directions, wherein the view forming arrangement comprises a first array of first optical elements, each first optical element aligned with light emitted in a normal direction from a respective first sub-array of display pixels, wherein the first optical elements implement a 3D view forming function for directing the light output from different pixels of the sub-array in different directions, and a second array of second optical elements aligned with light emitted in a normal direction from other display pixels forming a second sub-array of pixels, wherein the second optical elements implement a 2D viewing function, and wherein the display device is operable in a 3D mode in which image data in respect of a 3D image to be displayed is provided to the first sub-array of the display pixels and 2D content of the 3D image is provided to the second sub-array of the display pixels.

Note that the term “pixel” is used to denote the smallest display element. In practice, this will be a single colour sub-pixel. Thus, unless the context makes clear that the word “pixel” is being used to denote a group of smaller sub-pixels, the term “pixel” should be understood to be the smallest addressable element.

The arrangement of the invention provides a display which incorporates 2D pixels between the optical elements of an autostereoscopic viewing arrangement. In this way, the autostereoscopic viewing arrangement does not cover the entire area of the display. The pixels under the 3D view forming elements are capable of rendering 3D viewing content, whilst those between the 3D view forming elements are capable of rendering 2D content with improved performance. The improved 2D performance can include sharpening of the edges of text letters or other straight lines in figures, whereby the 2D legibility is improved.

In some embodiments, the 2D performance may be further enhanced by in addition also rendering images on the 3D pixels, for example in areas of the image where no sharp details (such as straight edges) are present i.e. in uniform colour areas, gradient colour areas etc. This may increase the brightness in addition to the increased apparent resolution of the 2D image. Similarly, the 2D pixels can be used to render 3D content if the objects are at a depth equal to the panel, such that there is no disparity and the local content for every view will be the same.

Preferably, the “sub-array of pixels” and the “other display pixels” together constitute all the pixels.

In a first set of examples, the first optical elements comprise elongate lenses, such as lenticular lenses (in particular plano-convex lenticular lenses) or graded refractive index lenses. They can be slanted or aligned with respect to the column direction. The second optical elements are then positioned between adjacent lenses. This means that upright or slightly slanted display portions provide a higher resolution 2D display capability. These upright portions can improve the rendering of vertical lines as appears in text.

The second optical elements can extend the full length of the elongate lenses, or else comprise discontinuous portions along the length direction of the lenses. In either case portions of upright pixel groups which are viewed at full resolution can be provided. The second optical elements can be positioned between each adjacent pair of the lenses, or the lenses can be grouped, with the second optical elements provided between the adjacent groups of lenses. Different arrangements provide a different compromise between the loss of the number of views in 3D pixels and the gain of improved 2D sharpness.

Each elongate lens can have a length which is less than half the corresponding screen dimension (i.e. the height or slanted height of the display screen) such that at least two lenses are provided along the corresponding screen dimension, with second optical elements between the ends of the lenses. In this way, horizontal lines can also be rendered using the 2D pixels. Depending on the desired application, the device may be designed to improve the 2D rendering of vertical or horizontal lines, or both.

The first optical elements can instead comprise microlenses, and the second optical elements surround each micro lens or groups of micro lenses. This means horizontal and vertical lines can be rendered in 2D.

The first optical elements can instead comprise barrier openings, and the second optical elements are provided between adjacent barriers. Thus, the invention can be applied to lens as well as barrier type autostereoscopic displays.

In all cases, the display can have green pixels beneath the second optical elements, or pixels of all colours used by the display beneath the second optical elements. Even with only green pixels, the perceived sharpness can be improved.

The second optical elements can comprise planar non-lensing surfaces, so that implement a simple pass through function. However, they can comprise lensing surfaces with a different lens function to the first optical elements, or scattering elements. These can be used to increase the field of view of the pixels viewed through the second optical elements.

A polarization selecting layer can be provided over the view forming arrangement, such that only light from the sub-array of pixels which has passed through the first optical elements is output, and only light from the other pixels which has passed through the second optical elements is output. This provides a way to avoid cross talk between the two types of pixels.

If the display provides a polarized output, then a polarization rotator can be associated with either the sub-array of pixels or the other pixels. If the display provides a non-polarized output, then it can be provided with a second polarization selecting layer.

An alternative way to prevent cross talk is to use a barrier structure extending between the display and the view forming arrangement, to prevent light from the sub-array of pixels reaching the second optical elements and to prevent light from the other pixels reaching the first optical elements.

Another way to improve the angular viewing of the pixels associated with the second optical elements is for the sub-array of pixels to be provided at one distance from the view forming arrangement, and the other pixels to be provided at a different distance from the view forming arrangement.

The invention also provides a method of delivering content to an autostereoscopic display device which comprises a display having an array of display pixels for producing a display output and a non-switchable view forming arrangement arranged in registration with the display for projecting a plurality of views towards a user in different directions, wherein the method comprises: in a 3D mode, providing image data in respect of a 3D image to be displayed to a first sub-array of the display pixels, wherein the light emitted in a normal direction from the first sub-array of pixels passes through a first array of first optical elements of the view forming arrangement, wherein the first optical elements implement a 3D view forming function for directing the light output from different pixels of the first sub-array in different directions; in a 2D mode, providing image data in respect of a 2D image to a second sub-array of the display pixels, wherein the light emitted in a normal direction from the second sub-array of pixels passes through a second array of second optical elements of the view forming arrangement, wherein the second optical elements implement a 2D viewing function; wherein in the 3D mode 2D content of the 3D image is provided to the second sub-array of the display pixels.

This method enables 2D and 3D modes to be implemented without needing to provide a switchable view forming arrangement. The first and second sub-arrays preferably together define all the pixels, and there is no overlap between the two sets.

In the 2D mode, image data in respect of the 2D image can also be provided to the first sub-array of the display pixels.

### BRIEF DESCRIPTION OF THE DRAWINGS

Examples of the invention will now be described in detail with reference to the accompanying drawings, in which:

FIG. 1 shows a known autostereoscopic display device;

FIG. 2 shows the light paths for the display of FIG. 1;

FIG. 3 shows how different 3D views are formed using the display of FIGS. 1 and 2;

FIG. 4 shows the relationship between the 2D display panel and a 3D view as seen from one particular viewing direction;

FIG. 5 shows an alternative pixel layout to the RGB pixels used in the device of FIG. 4, suitable for a microlens display;

FIG. 6 shows the device of the invention in schematic form;

FIG. 7 shows a view as seen from one particular viewing direction for a first example of device of the invention;

FIG. 8 shows a view as seen from one particular viewing direction for a second example of device of the invention;

FIG. 9 shows a third example of device of the invention;

FIG. 10 shows a fourth example of device of the invention;

FIG. 11 shows a view as seen from one particular viewing direction for a fifth example of device of the invention;

FIG. 12 shows a sixth example of device of the invention;

FIG. 13 shows a seventh example of device of the invention;

FIG. 14 shows an eighth example of device of the invention;

FIG. 15 shows a ninth example of device of the invention;

FIG. 16 shows the effect of the specular reflective barriers used in the example of FIG. 15;

FIG. 17 shows a tenth example of device of the invention; and

FIG. 18 shows an eleventh example of device of the invention.

### DETAILED DESCRIPTION OF THE EMBODIMENTS

The invention provides an autostereoscopic display device in which a view forming arrangement comprises a first array of first optical elements associated with 3D pixels for generating 3D images, and a second array of second optical elements associated with other display pixels for generating 2D viewing images. In this way, an improved resolution 2D function is enabled without the need to make the display switchable between viewing modes.

Before describing the invention in detail, the configuration of a known autostereoscopic display will first be described.

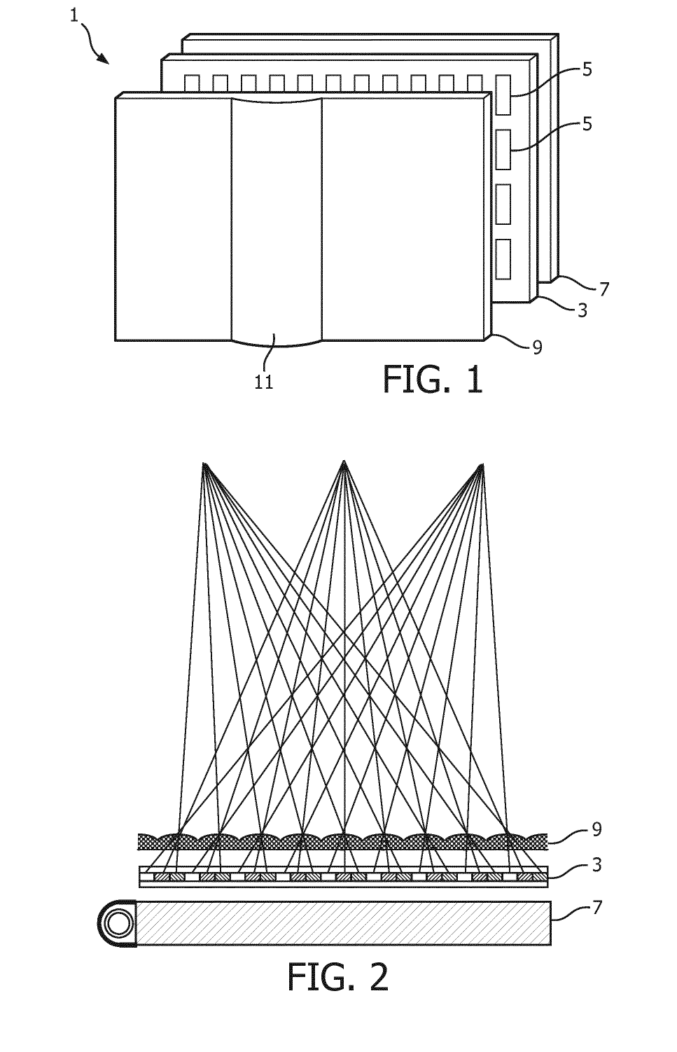

FIG. 1 is a schematic perspective view of a known multi-view autostereoscopic display device 1. The known device 1 comprises a liquid crystal display panel 3 of the active matrix type that acts as an image forming means to produce the display. The device can instead use OLED pixels.

The display panel 3 has an orthogonal array of display sub-pixels 5 arranged in rows and columns. For the sake of clarity, only a small number of display sub-pixels 5 are shown in FIG. 1. In practice, the display panel 3 might comprise about one thousand rows and several thousand columns of display sub-pixels 5.

The structure of the liquid crystal display panel 3 is entirely conventional. In particular, the panel 3 comprises a pair of spaced transparent glass substrates, between which an aligned twisted nematic or other liquid crystal material is provided. The substrates carry patterns of transparent indium tin oxide (ITO) electrodes on their facing surfaces. Polarising layers are also provided on the outer surfaces of the substrates.

Each display sub-pixel 5 comprises opposing electrodes on the substrates, with the intervening liquid crystal material there between. The shape and layout of the display sub-pixels 5 are determined by the shape and layout of the electrodes and a black matrix arrangement provided on the front of the panel 3. The display sub-pixels 5 are regularly spaced from one another by gaps.

Each display sub-pixel 5 is associated with a switching element, such as a thin film transistor (TFT) or thin film diode (TFD). The display sub-pixels are operated to produce the display by providing addressing signals to the switching elements, and suitable addressing schemes will be known to those skilled in the art.

The display panel 3 is illuminated by a light source 7 comprising, in this case, a planar backlight extending over the area of the display pixel array. Light from the light source 7 is directed through the display panel 3, with the individual display sub-pixels 5 being driven to modulate the light and produce the display.

The display device 1 also comprises a lenticular sheet 9, arranged over the display side of the display panel 3, which performs a view forming function. The lenticular sheet 9 comprises a row of lenticular lenses 11 extending parallel to one another, of which only one is shown with exaggerated dimensions for the sake of clarity. The lenticular lenses 11 act as view forming elements to perform a view forming function.

The lenticular lenses 11 are in the form of convex cylindrical elements, and they act as a light output directing means to provide different images, or views, from the display panel 3 to the eyes of a user positioned in front of the display device 1.

The autostereoscopic display device 1 shown in FIG. 1 is capable of providing several different perspective views in different directions. In particular, each lenticular lens 11 overlies a small group of display sub-pixels 5 in each row. The lenticular element 11 projects each display sub-pixel 5 of a group in a different direction, so as to form the several different views. As the user's head moves from left to right, his/her eyes will receive different ones of the several views, in turn.

FIG. 2 shows the principle of operation of a lenticular type imaging arrangement as described above and shows the light source 7, display panel 3 and the lenticular sheet 9. The arrangement provides three views each projected in different directions. Each sub-pixel of the display panel 3 is driven with information for one specific view.

The above described autostereoscopic display device produces a display having good levels of brightness. It is well known to slant the lenticular lenses at an acute angle relative to the column direction of the display pixel array. This enables an improved brightness uniformity and also divides the resolution loss in the horizontal and vertical directions more equally.

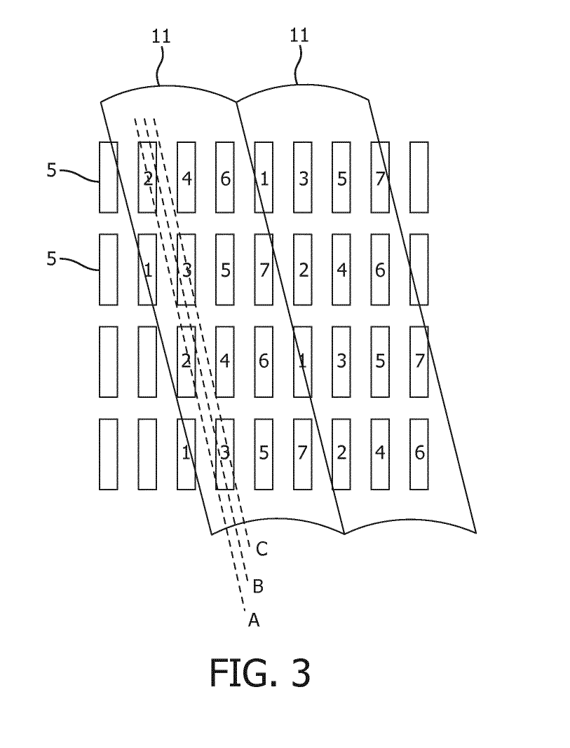

FIG. 3 shows how different pixel positions with respect to the lenticular lens axis give rise to different views. Each of the dotted lines A, B, C represents a line along the pixel array that is imaged to a different viewing direction. Line A passes through the centre of sub-pixels numbered as 2, so the light from these pixels is imaged in one direction, and together they form view 2 for example. Line C passes through the centre of sub-pixels numbered as 3, so the light from these pixels is imaged in a different direction, and together they form view 3 for example. Line B represents the location where there is cross talk between views 2 and 3. As shown, this arrangement has 7 views.

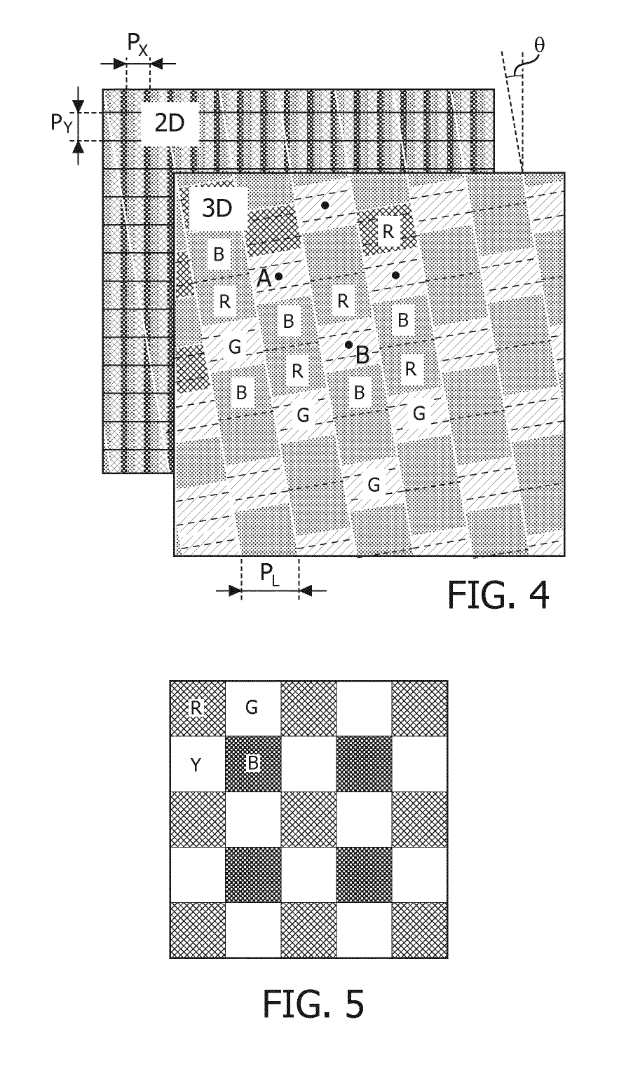

Whatever the mechanism used to obtain an auto-stereoscopic display system, resolution is traded for 3D depth: the more views, the higher the loss in resolution per view. This is illustrated in FIG. 4, which shows the native sub-pixel layout of the 2D display panel as well as, on the same scale, the sub-pixel layout in a 3D view obtained by putting a lenticular in front of the panel. The sub-pixel layout shown for the 3D image represents the sub-pixel pattern as seen from one viewing direction (i.e. the image of one set of the lines A, B, C of FIG. 3). The same geometric sub-pixel pattern is seen from all viewing directions, but different sets of sub-pixels of the underlying 2D display are visible. For a given viewing direction as shown, a blue 3D sub-pixel is an image of one or more sub-pixels of the native 2D display (and the same applies for green and red).

By way of example, this lenticular has a slant s=tan(θ)=⅙ and a lens pitch P_{L}=2.5 pₓ (where pₓ is the full RGB pixel pitch in the row direction) resulting in 15 views. As seen in FIG. 4, for the particular viewing direction shown, each 3D sub-pixel has contributions from three 2D sub-pixels (each 3D sub-pixel is divided into three sections). This is because a line parallel to the lenticular lens axis cross three sub-pixels of one colour, followed by three sub-pixels of the next colour, followed by three sub-pixels of the last colour. For different viewing angle directions, there can instead be two full sub-pixels for each 3D sub-pixel.

The examples above show the conventional RGB pixel layout . However, other pixel layouts are possible, such as the 4 sub-pixel RGBY (red, green, blue, yellow) pixel as shown in FIG. 5. This enables square pixels, and unity aspect ratio microlenses can be used to provide portrait and landscape 3D operation. For example, an array of 5×5 sub-pixels as shown in FIG. 5 can be provided under each microlens.

The invention can be implemented in various ways. The general concept is that the display has a 3D mode where only a subset of 3D sub-pixels is turned on. The viewing angle of the 3D mode can be limited to a single cone or it can be as broad as for a regular 3D lenticular display. The display also has a 2D mode where only the 2D subset of sub-pixels is turned on.

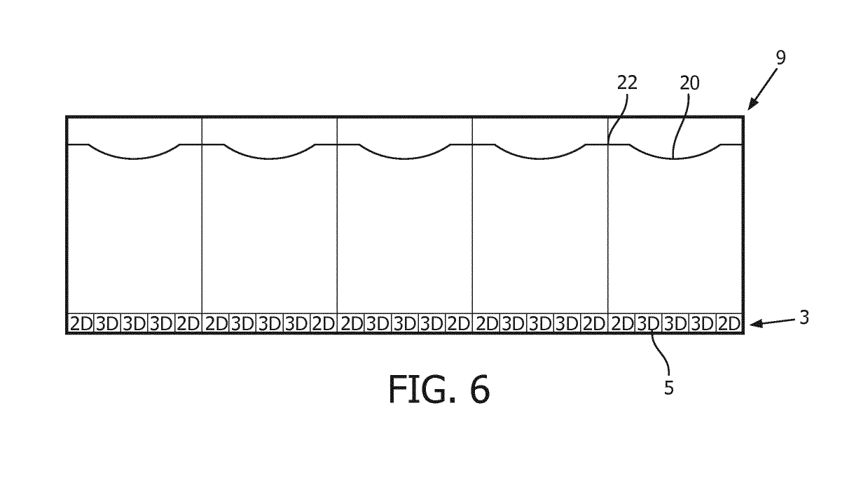

A schematic outline of a simplest implementation of the display of the invention is shown in FIG. 6, for providing a general explanation. More detailed examples are provided below.

This example is based on a display 3 having an array of display pixels 5 and a lenticular lens arrangement 9 providing the view forming function.

The lenticular array 9 has a first array of first lenses 20, each aligned with light emitted in a normal direction (i.e. perpendicular to the general plane of the display panel) from a respective sub-array of display pixels. These pixels are shown as “3D”. The pitch of the lens array is 5 sub-pixels, but the first lenses only cover a width of three sub-pixels. The lenses implement a 3D view forming function.

A second array of second optical elements 22 is aligned with light emitted in a normal direction from other display pixels. In this example, these elements 22 are aligned with two sub-pixels, marked “2D” in FIG. 6. The second optical elements 22 implement a 2D viewing function. In this example, they are flat areas, providing no scattering or lensing function.

In the figures, reference 20 will be used for the first optical elements, and reference 22 for the second optical elements, although these are of different type in the different embodiments.

In this way, there is a portion of the area of the lens arrangement which does not cover a subset of the pixels or sub-pixels for at least one direction of viewing.

The invention is of particular interest when the number of 2D pixels is such that the spatial resolution in 2D mode is higher than the resolution in 3D mode. In some embodiments, 3D pixels can be used to support the 2D mode.

In a most simple embodiment, the portion of the lenticular lens at positions along the meeting point of adjacent lenticular lenses is removed above a subset of the green sub-pixels. As a result, the majority of the display operates in an undisturbed 3D mode. However, as green sub-pixels are perceptually dominant for the creation of high resolution, then even with the addition of only green 2D sub-pixels, there can be an improved effect in sharpening the edges of objects such as text.

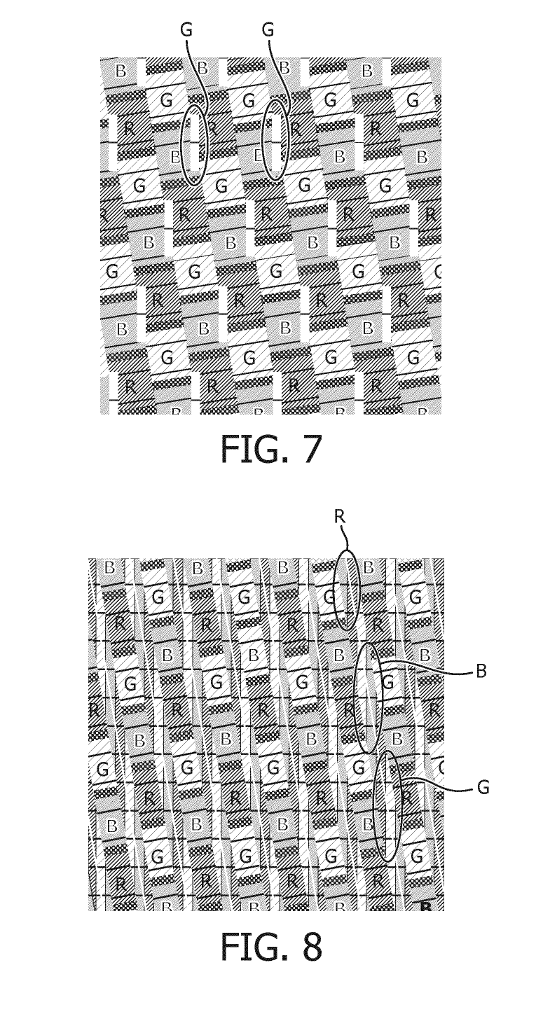

FIG. 7 shows the view from one viewing direction (i.e. similar to FIG. 4) for an arrangement with green sub-pixels at the non-lensing areas between the lenses. The result is that vertical green image sections are present between the 3D sub-pixel areas as shown. In FIG. 7, a zone is used without lensing function which does not extend the full length of the lenses. Instead, non-slanted rectangular openings are used with the slanted lens. In this way, small vertical pixel groups are visible in 2D to form vertical edges. The bare 2D pixels can be displayed undistorted within a small viewing angle.

In a more extended embodiment, the removed portion of the lenticular lens (which is at the meeting point of adjacent lenticular lenses in this example) is above a subset of the green sub-pixels and in addition subsets of the red and blue sub-pixels. The majority of the display operates in an undisturbed 3D mode. This embodiment is effective in sharpening the edges of objects such as text whilst allowing higher resolution 2D with a wider colour gamut. A layout according to this embodiment is shown in FIG. 8. In this case, there are vertical red, green and blue image sections present between the 3D sub-pixel areas, as shown. Furthermore, the space for 2D pixels extends the full length of the lenses, creating a continuous band in the lens axis direction of 2D pixels.

In the above examples, the lenticular lenses are slanted. However, good 3D performance may also be realised using non-slanted lenticular lenses with fractional spacing (i.e. a lens pitch which is a non-integer multiple of the sub-pixel pitch). (Of course the combination of slanted lenticular lenses with fractional spacing is not excluded.)

By using such a non-slanted lenticular arrangement and opening a subset of the green sub-pixels, for example, along the same column of the display, it is possible to realise perceptually extremely sharp vertical lines. Such an arrangement is highly suitable for text. Without slanting of the lenticular lens, banding has to be prevented using any of the known techniques.

Examples of known techniques are to slant the pixels instead of the lenses such that pixels partially overlap in column direction, or to adjust the focus characteristics of the lens for instance by introducing facets or a diffuser layer.

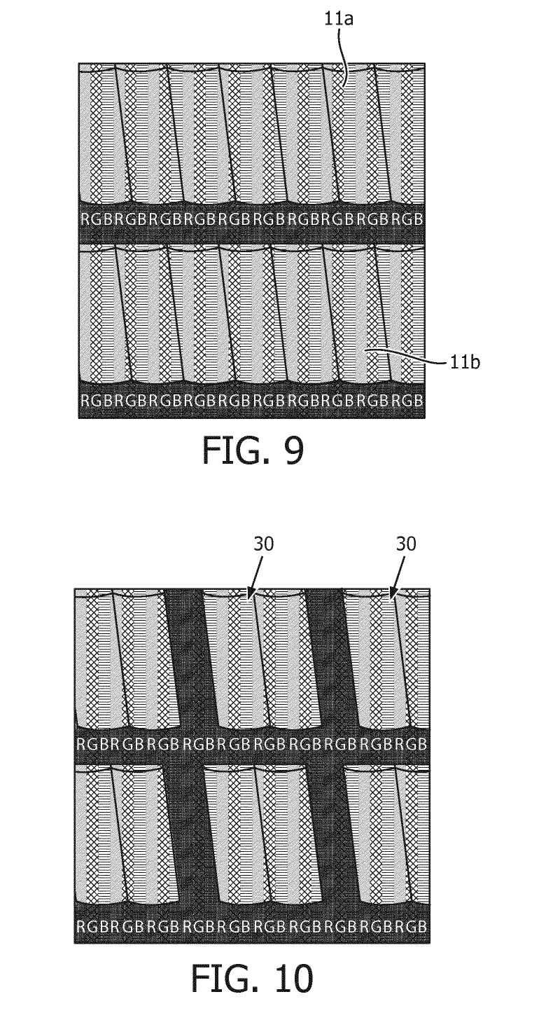

The examples above make use of spacing between lenses in the row direction. FIG. 9 shows an alternative in which each lens element 11 can be split into segments 11a, 11b along the direction perpendicular to the lens pitch (i.e. along the lens axis direction). FIG. 9 shows two segments but there can be a large number of segments, so that regular regions are provided across the display height where sharp horizontal lines of a 2D image can be displayed. In the area in between the segments 11a, 11b, pixels not covered with the lens elements will operate in 2D mode. In this way 2D pixels can be arranged along the horizontal row direction. Such positioning of 2D pixels allows to increase their angular range of visibility compared to the case when the 2D pixels are located between the lenses along the pitch direction.

In the example of FIG. 10, portions of the lenticulars lens elements 11 can be removed both in parallel and perpendicular directions with respect to the lens pitch direction. In this way, the lenticular lenses are organized in segments 30, defining 3D pixels, and the pixels located in the areas between the segments 30 extend essentially in the row and column directions (or more accurately in the lens pitch direction and the lens axis direction). These gaps will operate in the 2D mode. This enables the display of both sharp vertical and horizontal lines in the 2D mode.

The examples above make use of lenticular lenses, in particular plano-convex lenticular lenses. Elongate lenses (i.e. lenticular lenses) can also be formed using graded refractive index lenses.

The same concept can also be applied to displays in which microlenses are used as the 3D view forming arrangement. This is a known approach, for example for a portrait/landscape display. There will be a set of sub-pixels covered by an associated microlens, and there will also be at least some sub-pixels which are not covered by the microlens i.e. some space is created between at least some portions of the microlenses.

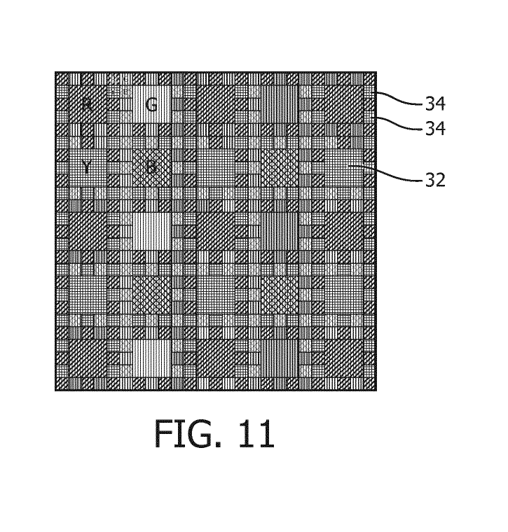

FIG. 11 shows an arrangement using a RGBY display. The display has a regular sub-pixel array, like FIG. 5. The microlenses each cover a 3×3 sub-array with a two sub-pixel gap between microlenses (as in FIG. 6). The microlenses mean that for a given viewing direction (for one of which the view of a display is shown in FIG. 11), the 3×3 sub-array generates a single colour sub-pixel 32 of the 3D image, whereas in the areas between microlenses (the two-pixel gap) the individual 2D sub-pixels 34 are visible. These individual pixels viewed in the 2D mode include all the different sub-pixel colours in the example shown.

In the most simple embodiment, only that portion of the microlens e.g. at positions along the meeting point of adjacent microlenses—is removed above a subset of the green sub-pixels. As a result, the majority of the display operates in an undisturbed 3D portrait/landscape mode. However, as explained above, green sub-pixels are perceptually dominant for the creation of high resolution, so this can already be effective in e.g. sharpening the edges of objects such as text.

The microlenses can be on a rectangular grid aligned with the rows and columns (as described above) or on a slanted grid such as a slanted rectangle (parallelogram).

The concepts above can be applied to displays using barrier arrangements as the view forming arrangement. In this case, there are at least some (sub-) pixels which are not covered by the barriers i.e. some additional spacing is created between at least some portions of the barriers. A standard barrier arrangement with a split for 2D areas between the 3D barrier areas will enable 2D viewing for the central cone only.

The spaces occupied by the 2D pixels can have different shapes. In FIG. 7 non-slanted rectangular openings are used with a slanted lens such that bare 2D pixels can be displayed undistorted within a small viewing angle. In the example of FIG. 8 the openings run along the entire lens exposing lines of pixels. Other shapes are possible, both in the row and column directions, so that 2D pixels are present to form sharp edges. As shown above, row direction 2D areas can be formed by dividing the lenses along the lens direction into segments. This partially solves the problem of the reduced angular visibility of 2D pixels since if rows of 2D pixels are present, they can be viewed from all angles of observation.

In the example above, the 2D pixels are formed identically to the 3D pixels, in a basic array with all pixels at the same distance from the view forming arrangement. As a consequence, there will be improved 2D performance for only a limited viewing angle. This will typically be sufficient for reading text on a smart phone or small tablet at a comfortable viewing distance of ˜0.5m, whilst 2D performance will drop off towards the side of a laptop or desktop monitor screen.

Instead, the 2D pixels may have a different structure to the 3D pixels in order to improve the viewing angle for the 2D pixels.

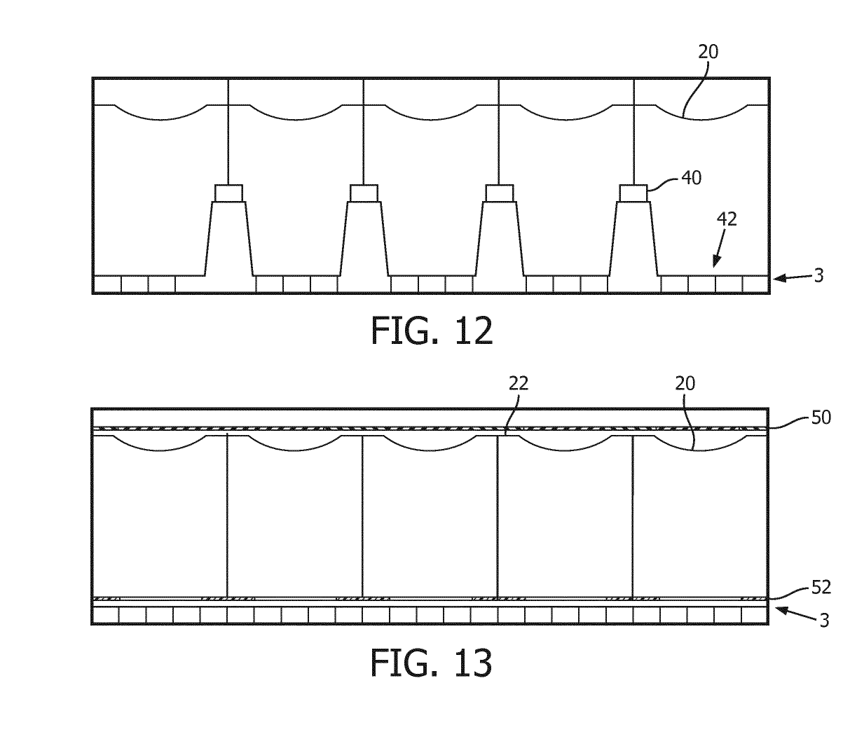

FIG. 12 shows an example in which the 2D pixels 40 are raised with respect to the 3D pixels 42. In this way, the 2D pixels 40 are positioned at a position closer to the imaging arrangement than the 3D pixels 42. In order to also provide good 2D performance at the edges of desktop monitors, a pixel raised by 50% or more of the spacer thickness can for example be used.

This offset is not straightforward with LCD panels due to the requirement to fill a small cell gap with LC material, but can more easily be realised with emissive displays such as OLED displays, which form the preferred implementation of this embodiment.

FIG. 12 shows single sub-pixels raised (for example green sub-pixels) but of course multiple adjacent sub-pixels may be elevated.

It may be desired to prevent the light that emanates from the 2D pixels to interact with the optical elements with 3D view forming function. Similarly, light from 3D pixels may be prevented to interact with the optical elements with 2D view forming function. There are various ways to achieve separation of the light from the 2D and 3D pixels.

FIG. 13 shows an approach based on the use of a patterned polarizer. The patterned polarizer 50 is near the lens interface. Polarization is used to distinguish light from the 2D and 3D light path.

For display panels that output polarized light (e.g. LCD), also a patterned half-wave plate 52 (i.e. retarder) is added to the display stack. This layer 52 should be near to or integrated with the display panel.

The light output from the display, after passing through the patterned wave plate 52 then has regions with two orthogonal polarizations. Light originating from the 2D pixels has a first polarization and light originating from the 3D pixels has a second polarization (which in this example is the polarization as output from the display). Of course, the wave plate portions may be associated with the 3D pixels instead of the 2D pixels as shown in FIG. 13.

The polarizer 50 at the lens side has different regions for the 2D and 3D pixels, and functions as a selective filter, so that only light from the 3D pixels can pass the part of the polarizer 50 which lies above the first optical means 20, and only light from the 2D pixels can pass the part of the polarizer which lies above the second optical means 22. (Thus the polarizer portions over the lenses 20 block the first polarization and pass the second polarization, whereas the polarizer portions over the second optical element 22 pass the first polarization and block the second polarization.) Alternatively (not shown in the figures) the polarizer 50 can be put at the other side of one or both of the first and second optical means (20; 22). It may then also be directly attached to the first and second optical means (20; 22) so that it has the same shape as the shape of the first and second optical means (20; 22). Then the selection of light of the appropriate polarization is already made before the light can reach the first and/or second optical means (20; 22).

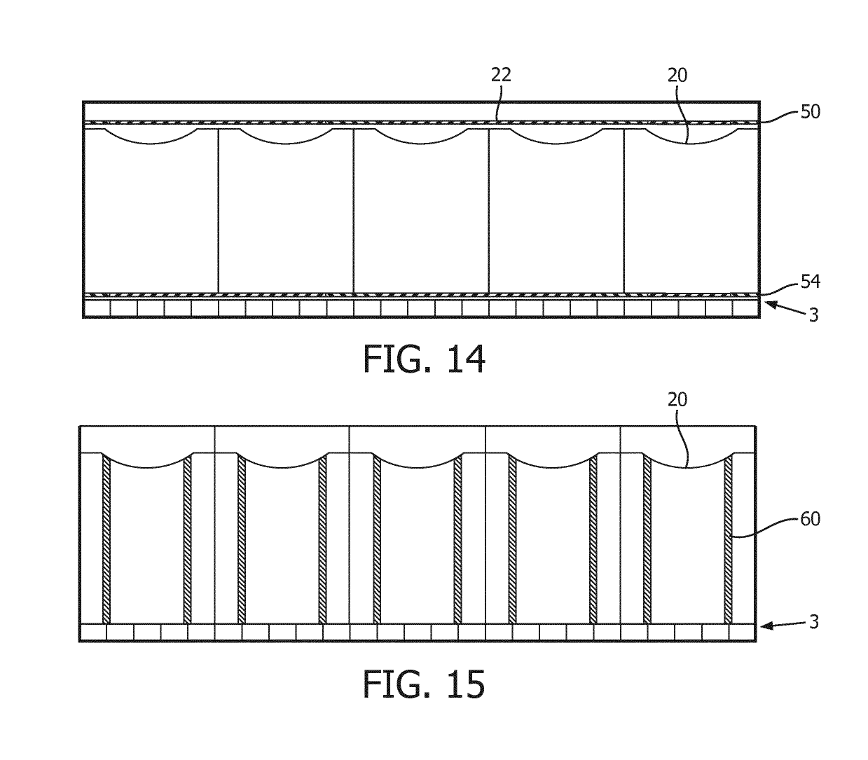

For display panels that output non-polarized light (e.g. OLED) instead of the patterned half-wave plate 52, a second patterned polarizer 54 is added as shown in FIG. 14 also near to or integrated with the display panel.

Again, the light output from the display, after passing through the patterned polarizer 54 then has regions with two orthogonal polarizations. Light originating from the 2D pixels has a first polarization as a result of first parts of the polarizer 54 and light originating from the 3D pixels has a second polarization as a result of second parts of the polarizer 54.

These arrangements essentially create a barrier configuration for the 2D image content and a lenticular configuration for the 3D image content. There will however be crosstalk between the 2D and 3D pixels outside the primary cone and if displaying only 2D content, this will result in angular space that is black.

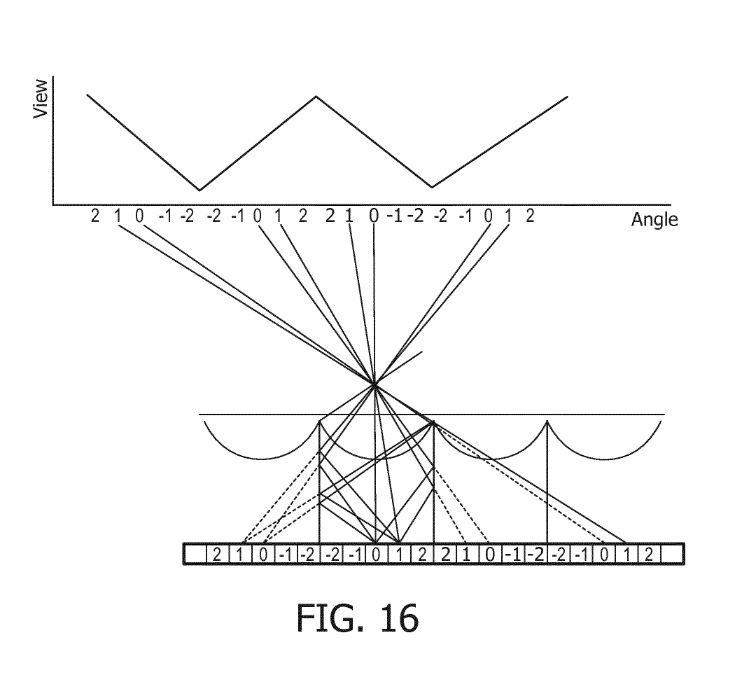

Another approach shown in FIG. 15 is to add walls 60 in the spacer where each side of the wall can have either diffuse reflective, specular reflective or absorbing function. It is preferred, but certainly not required, that the sides facing 3D pixels are absorbing. This has the effect of limiting the viewing angle of the display, which is acceptable for personal and handheld devices. If on the other hand, the sides facing 3D pixels are specular reflective, then the two secondary cones have views in opposite order (mirrored), tertiary cones have views again in normal order, etc. This effect is shown in FIG. 16.

Without eye tracking this will act as a cyclic cone, and with eye tracking mirroring is compensated with reverse order of views rendering in the case the observer is in the single-mirrored cone. FIG. 16 shows that the reflections from the side walls mean that the viewing cones to each side of the primary viewing cone are formed by reflected rays, which result in a different order of the view number with respect to the regular 3D display. Thus, instead of a cyclic sawtooth ramp function of the view number (−2,−1,0,1,2,−2,−1,0,1,2, . . . ) for a conventional display, a triangular function results as shown (2,1,0,1,2,2,1,0,1,2,−2,−1,0,−1,−2,2−,2− . . . ). The display rendering can compensate for this if head tracking is used.

If the intended use is to combine 2D and 3D pixels to form one image, then 2D pixels should have a limited viewing angle. The resolution and brightness of the display is increased for the full frontal viewing position. The viewing angle is limited by having the sides facing 2D pixels absorbing (i.e. black).

If, on the other hand, the 2D pixels are to be used only in isolation, so there is a 2D mode where only 2D pixels are used, and there is a 3D mode where 3D pixels are used, then they should have a wider viewing angle. In this case it is advantageous to have diffuse or specular reflective side walls. For some viewing angles there will be a ‘flipped’ image (i.e. every pair of 2D pixels is mirrored). This could be solved by not using the 2D pixels in pairs, but using single 2D pixels between the 3D pixels. Alternatively the neighbouring pixels should have different colours.

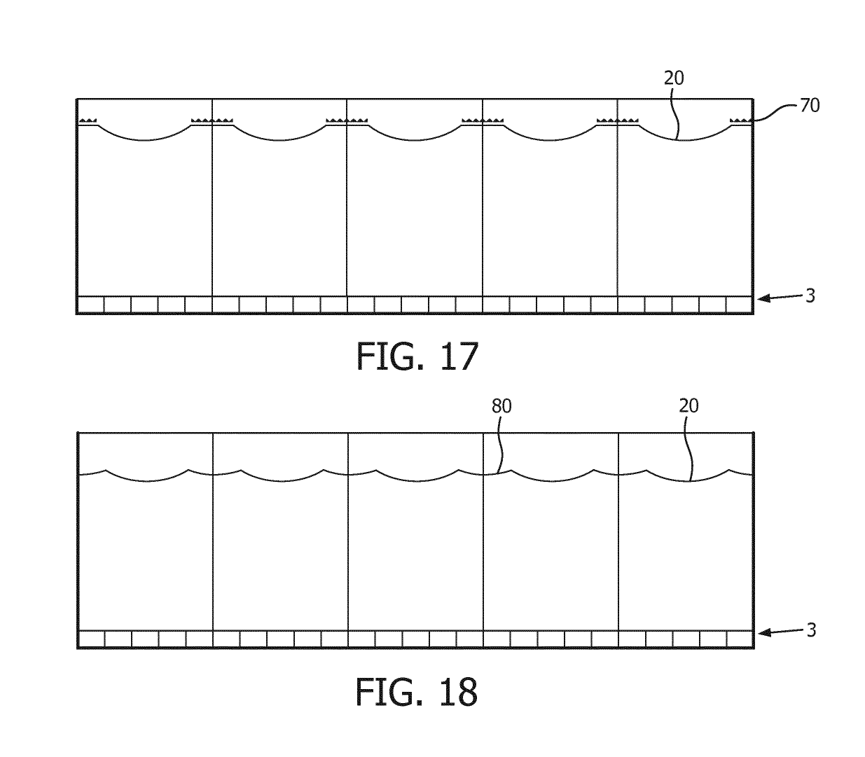

The 2D pixels should be visible in both eyes. It is possible to enlarge the viewing angle of the 2D pixels, for instance by adding a scattering element. This approach is shown in FIG. 17, where the scattering elements are shown as 70. Alternatively, the space between the view forming lenses can be less powerful lenses 80 as shown in FIG. 18. In this case placement of multiple 2D sub-pixels side-by-side under second optical elements should be avoided, unless they have different colours.

The scattering elements or lenses may vary over the display, for instance so there may be a prism function to direct light from the 2D sub-pixels more towards the intended viewer.

It is preferred to render text using fonts with predominantly vertical and (for microlenses) horizontal (not sloping) lines. More preferably to use fonts where the lines appear at the same horizontal positions and to align these positions to the 2D pixel positions in the display. In this manner, the sharpness of letters in textual rendering is significantly improved. Thus, the display output can be tailored to the design of the pixel and view forming arrangement, to obtain the best results.

The display of the invention can be used with locally selectable modes, such as:
2D rendering by using only the pixels that are associated with 2D rendering (this can be considered a 2D only mode);
3D rendering by using only the pixels that are associated with 3D rendering (this can be considered a 3D only mode);
Hybrid 2D/3D rendering by using all pixels. In 3D mode, the resolution for content near zero disparity (i.e. at screen depth) will be boosted by also using the 2D pixels (this can be considered a hybrid 3D mode) while for 2D mode brightness can be increased at areas of the 2D image where no sharp details are present by also using the 3D pixels (this can be considered a hybrid 2D mode); and
Eye tracked rendering where a face, head and/or eye tracker is used to estimate the position of the eyes of the observer(s) in correspondence to the display. Based on that, a visibility model estimates the visibility in between [0, 100%] of each sub-pixel (whether in 2D or 3D area) for each eye. Each sub-pixel is then assigned a value taking into account its visibility, a crosstalk/brightness/sharpness trade off, possibly applying also other operations such as anti-crosstalk filtering.

Eye tracked rendering is compatible with all other embodiments. The hybrid 2D/3D rendering is only compatible with the embodiments that separate the 2D and 3D light paths.

It is apparent from the above description that the display of the invention can be operated in 2D mode where only the 2D subset of sub-pixels is turned on. Typically, those sub-pixels would have been on the cone edge in a regular lenticular display, but by the view forming arrangement of the invention these sub-pixels are visible from a frontal viewing position.

The viewing angle of the 2D mode is preferably made large enough that the 2D image should be visible to both eyes, so that some examples show how this viewing angle can be widened. A narrow viewing angle can be used so that the 2D and 3D mode can be mixed. This allows for improved resolution at full frontal viewing. Furthermore, some examples show how red and blue 3D sub-pixels can combine with green 2D sub-pixels. Thus, it will be seen that there are various implementations possible to achieve different effects.

It is further noted that the 2D-pixels and the 3D-pixels do not need to have the same distribution over the full display panel. For instance if it is known that particular parts of the screen are often used for still (or “semi-still”) pictures it can be advantageous to enhance the concentration of 2D-pixels and consequently lower the concentration of 3D-pixels in those parts. This is for instance the case for subtitles which normally are placed at the lower part on the screen and for logos which are often placed at the upper left corner or the upper right corner of the screen. In these particular examples these parts are in the periphery of the screen and thus it is likely not very disturbing to the viewer if the 3D-resolution is lowered at these parts only. However the increase in 2D-resolution in these parts will have a noticeable and advantageous effect on the perceived sharpness of these parts (subtitles, logo's etc.).

The display is configured such that the first sub-array of pixels are always designated as 3D pixels, in that there is a non-switchable optical element (lens or barrier opening) over those pixels, so that their output is always presented in different directions by the view forming function. The second sub-array of pixels are always designated as 2D pixels in that there is a non-switchable second optical element over those pixels which does not perform a view forming function.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. An autostereoscopic display device comprising:
a display having an array of display pixels arranged to produce a display output,
a non-switchable view forming arrangement arranged in registration with the display for projecting a plurality of views towards a user in different directions,
wherein the view forming arrangement comprises a first array of first optical elements, each first optical element aligned with light emitted in a normal direction from a respective first sub-array of RGB or RGBY display pixels, wherein the first optical elements implement a three dimensional view forming function for directing the light output from different pixels of the sub-array in different directions, and a second array of second optical elements aligned with light emitted in a normal direction from other display pixels forming a second sub-array of display pixels, wherein the second optical elements implement a two dimensional viewing function,
wherein the display device is operable in a three dimensional mode in which first image data of a displayed image is provided to the first sub-array of the display pixels to create an autostereoscopic three dimensional viewing, and second image data of the displayed image is provided to the second sub-array of the display pixels to create a two dimensional viewing,
and wherein the second sub-array of display pixels comprises green pixels or pixels of all RGB or RGBY colors used by the display.

2. An autostereoscopic display device as claimed in claim 1, wherein the first optical elements comprise elongate lenses.

3. An autostereoscopic display device as claimed in claim 2, wherein the second optical elements are positioned between adjacent lenses.

4. An autostereoscopic display device as claimed in claim 3, wherein the second optical elements extend the full length of the elongate lenses.

5. An autostereoscopic display device as claimed in claim 3, wherein the second optical elements are positioned between each adjacent pair of the elongate lenses.

6. An autostereoscopic display device as claimed in claim 2,
wherein each elongate lens has a length which is less than half the corresponding display dimension,
wherein at least two lenses are provided along the corresponding display dimension, with second optical elements between the ends of the lenses.

7. A device as claimed in claim 1,
wherein the first optical elements comprise microlenses, and the second optical elements surround at least one microlens.

8. A device as claimed in claim 1, wherein the display has green pixels beneath the second optical elements.

9. An autostereoscopic display device as claimed in claim 1
wherein the second optical elements comprise planar non-lensing surfaces.

10. An autostereoscopic display device as claimed in claim 1, further comprising a polarization selecting layer over the view forming arrangement, such that only output is from light from the sub-array of pixels which has passed through the first optical elements, and light from the other pixels which has passed through the second optical elements.

11. An autostereoscopic display device as claimed in claim 10,
wherein the display provides a polarized output
wherein a polarization rotator is associated with either the sub-array of pixels or the other pixels.

12. An autostereoscopic display device as claimed in claim 1, further comprising a barrier structure extending between the display and the view forming arrangement, wherein the barrier structure prevents light from the sub-array of pixels from reaching the second optical elements and prevents light from the other pixels from reaching the first optical elements.

13. An autostereoscopic display A device as claimed in claim 1, wherein the sub-array of pixels are provided at one distance from the view forming arrangement and the other pixels are provided at a different distance from the view forming arrangement.

14. A method of delivering content to an autostereoscopic display device which comprises a display having an array of display pixels arranged for producing a display output and a non-switchable view forming arrangement arranged in registration with the display for projecting a plurality of views towards a user in different directions, the method comprising:
in a three dimensional mode, providing first image data in respect of a three dimensional image to be displayed to a first RGB or RGBY sub-array of the display pixels, wherein the light emitted in a normal direction from the first sub-array of pixels passes through a first array of first optical elements of the view forming arrangement, wherein the first optical elements implement a three dimensional view forming function for directing the light output from different pixels of the first sub-array in different directions, wherein in the three dimensional mode second image data in respect of the three dimensional image is provided to the second sub-array of the display pixels for two dimensional viewing, wherein the second sub-array of pixels comprises green pixels or pixels of all RGB or RGBY colors used by the display;
in a two dimensional mode, providing image data in respect of a two dimensional image to a second sub-array of the display pixels, wherein the light emitted in a normal direction from the second sub-array of pixels passes through a second array of second optical elements of the view forming arrangement, wherein the second optical elements implement a two dimensional viewing function.

15. A method as claimed in claim 14, wherein: in the two dimensional mode, image data in respect of the two dimensional image is also provided to the first sub-array of the display pixels.

16. An autostereoscopic display device as claimed in claim 1, wherein the first optical elements comprise lenticular lenses.

17. A device as claimed in claim 16, wherein the second optical elements are positioned between adjacent lenses.

18. A device as claimed in claim 3, wherein the second optical elements comprise discontinuous portions along the long direction of the elongate lenses.

19. A device as claimed in claim 3, wherein the elongate lenses are grouped, with the second optical elements provided between the adjacent groups of elongate lenses.

20. A device as claimed in claim 1, wherein the first optical elements comprise barrier openings, and the second optical elements are disposed between adjacent barriers.

21. An autostereoscopic display device as claimed in claim 1, wherein the second optical elements comprises lensing surfaces with a different lens function to the first optical elements.

22. An autostereoscopic display device as claimed in claim 10, wherein the display provides a non-polarized output and is provided with a second polarization selecting layer.
